(19) United States
(12) Patent Application Publication
(10) Pub. No.: US 2010/0089722 A1
(43) Pub. Date: Apr. 15, 2010

(54) CONVEYING MEANS FOR AN OVERHEAD CONVEYER

(75) Inventors: Bernhard Wiedemann, Hofstetten (DE); Rolf Schoenenberger, Landsberg/Lech (DE)

Correspondence Address: ROTHWELL, FIGG, ERNST & MANBECK, P.C., 1425 K STREET, N.W., SUITE 800, WASHINGTON, DC, 20005, US

(73) Assignee: RSL LOGISTIK GmbH, Landsberg (DE)

(21) Appl. No.: 12/527,464

(22) PCT Filed: Oct. 26, 2007
(86) PCT No.: PCT/EP07/09323

§ 371 Date: Sep. 3, 2009

(30) Foreign Application Priority Data
Feb. 16, 2007 (DE) 10 2007 007 837.6

(51) Int. Cl. B65G 17/24; B65G 17/32

(52) U.S. Cl. 198/465.4; 198/803.14

(57) ABSTRACT

The invention relates to a conveying means which is intended for an overhead conveyer and has at least one running body (2, 4) which can be moved in a hanging state on a guide rail (30) and has a load-bearing body (6) with a hang-on portion (18) for receiving hooks (20) of article holders (22), e.g. clothes hangers, wherein the load-bearing body (6) has a free support (10) which, with the conveying means (1) hanging as intended on the guide rail (30) projects laterally outwards transversely to the guide rail (30) and has the hang-on portion (18) at its distal end, the hang-on portion (18) being free throughout on its top side, and it is therefore accessible from both opposite sides along the guide rail (30) in order to be fitted with a hook (20) of an article holder 22).

The invention relates to a conveying means for an overhead conveyor, which has at least one running body which can be moved in a hanging state on a guide rail and has a load-bearing body with a hang-on portion for receiving hooks of article holders, e.g. clothes hangers.

Conveying means of this type are known, for example, as so-called single-hanger carriers or also as multi-hanger carriers. Examples of single-hanger carriers can be found in DE 198 16 688 A1 and EP 0 623 497 A1. Examples of multi-hanger carriers can be found in EP 0 516 969 B1 and in DE 299 09 959 U1.

A typical field of application for such conveying means is the transport of clothes in clothing warehouses, laundries, etc. The clothes here hang on clothes hangers, which hang with their hooks on the hang-on portions of the conveying means. In the case of the known single-hanger carriers, each running body has a running roller pair, which running rollers, arranged on a common rotation axis, protrude to mutually opposite sides from an elongated frame part which in the conveying operation is normally aligned substantially vertically. The running bodies can be hung on the guide rail on one side with a respective running roller. For the details of such running bodies and of overhead conveyors equipped therewith, reference can be made, for example, to EP 0 623 497 A1 and DE 198 16 688 A1. The single conveying means which are known therefrom, i.e. conveying means for the individual transport of article holders and items located thereon, have at their lower ends a respective hook, on which a hook of an article holder can be hung up. If a single conveying means of this kind is arranged on the guide rail in the intended manner, the hook forming the hang-on portion is oriented in the forward or rearward direction in a vertical plane extending parallel or, where appropriate, tangentially to the running direction of the rail. The hanging of an article holder in the hook-shaped hang-on portion of the single conveying means can be realized in the running direction of the rail only from one side of the single conveying means, namely only from the side to which the hook aperture is open. The back of the hook forms in this respect an interfering contour, which makes the hang-on portion inaccessible from the other side.

In the multi-item conveying means according to EP 0 516 969 B1 and DE 299 09 959 U1, two running bodies which can be moved in a hanging state one behind the other on a guide rail, and a connecting element connecting the running bodies, are provided, this connecting element, which normally lies in a vertical center plane between these running bodies, forms the load-bearing body comprising the hang-on portion for hooks of article holders, for example clothes hangers. The connecting element here directly constitutes the hang-on portion. The connecting element is a connecting rod, which is connected at its ends to the running bodies. The connecting rod is long enough to receive a plurality of clothes hangers side by side. Conveying means of this type are used, in particular, also to compile goods deliveries and thus for commissioning purposes.

In the conveying means according to EP 0 516 969 B1 and DE 299 09 959 U1, the running bodies are configured as roller running gears having a V-shaped bracket, which at its two protruding free ends respectively supports a rotatably mounted running roller. In the conveying operation, each bracket rests with its running rollers on outer angular faces of a guide rail having a pitched roof profile, so that the bracket hangs with its apex downward. The connecting rod, at its two end face ends, is articulately connected by a hinge arrangement to the brackets of the roller running gears.

The known conveying means have proved themselves in practice. It has in part proved difficult, however, to load them with items, i.e. for example clothes hanging on clothes hangers, and to take the clothes hangers back off with the items hanging thereon.

The object of the invention is to provide a conveying means of the type stated in the introduction, which can be more easily loaded and unloaded automatically with article holders, for example clothes hangers, and has a simple structure.

Starting from a conveying means having the features stated in the introduction, this object is achieved according to the invention by virtue of the fact that the load-bearing body has a cantilever, which, with the conveying means hanging in the intended manner on the guide rail, protrudes laterally transversely to the guide rail and has the hang-on portion at its distal end, the hang-on portion being continuously free on its top side, so that it can be accessed from both mutually opposite sides along the guide rail so as to be fitted with a hook of an article holder.

The result is that in the longitudinal direction of the guide rail no interfering contours of mounting parts of the hang-on portion are present, which would make the fitting of the load-bearing bodies with hooks of article holders and, in particular, the transfer of such hooks between adjacent conveying means, more difficult.

Preferably, the conveying means has on its running body at least one running roller, with which the running body can be hung on the guide rail for movement thereon, the load-bearing body—viewed in the running direction of the conveying means along the guide rail—displaying a hook profile, the free hook profile end (hook point) of which forms the hang-on portion. Should it be wished to reconfigure a single conveying means according to DE 198 16 688 A1 or EP 0 623 497 A1 in the manner according to the invention, then the hook of the known conveying means would have to be aligned twisted by 90°, so that the hook aperture is oriented in a plane transversely to the guide rail, the free hook end, furthermore, having to be reconfigured into a hang-on portion on which a hook of an article holder is to be securely hung. In the normal situation in which a multiplicity of similar articles are to be loaded side by side on the guide rail with article holders, in the solution according to the invention considerable handling benefits are obtained. For instance, it is easily possible to dispense the article holders out of a bundle to the conveying means according to the invention, since in the running direction of the rail no interfering contours are present between the hang-on portions of the conveying means.

Preferably, the conveying means according to the invention has one or, where appropriate, a plurality of running bodies with a respective roller pair, the running rollers protruding to mutually opposite sides from an elongated frame part which in the conveying operation is normally aligned substantially vertically, and the respective running body having to be hung on the guide rail on one side with a respective running roller. Running bodies of this type are known, for example, from DE 198 16 688 A1 or EP 0 623 497 A1.

Preferably, the conveyor means according to the invention has on the elongated frame part of the running bodies friction coupling means for frictional coupling of the respective running body to a friction belt, which is moved along the guide rail in a guided manner and is provided for the frictional transport of the conveying means along the conveying section.

It is further proposed that the running bodies have release-tripping means, which, in the event of a logjam of the conveying means on the conveying section, bring about a suspension, or at least a reduction, of the frictional coupling of the friction coupling means to the friction belt, the release-tripping means, in the logjam of mutually adjacent running bodies of successive conveying means, interacting with each other. Such release-tripping means on running bodies are known per se, for example, from EP 0 623 497 A1 and DE 198 16 688 A1.

In a particularly preferred embodiment of the invention, the conveying means has at least two running bodies, which can be moved one behind the other in a hanging state on a particular guide rail and are mutually connected, and which jointly support the load-bearing body. With such a solution, the inventive concept of the design of the hang-on portions which in the direction of the running rail is free from interfering contours can be transferred to a conveying means for a plurality of article holders, for example clothes hangers.

Preferably, the load-bearing body here has an elongated holding bar, which runs along, in particular parallel to, a shortest connecting line between the running bodies and is held by means of cantilevers and forms the hang-on portion. By “cantilever” is also meant, in this illustrative embodiment, a laterally protruding support structure, which has the hang-on portion at its distal end and hence has no connecting struts there which point upward, i.e. toward the running body.

Such a conveying means is then normally designed such that the load-bearing body—viewed in the running direction of the conveying means along the guide rail—displays a hook profile, the free hook profile end of which forms the hang-on portion.

According to one variant of a multi-item conveying means of this kind, the holding bar forms a connecting element, which is supported at their distal ends by two cantilevers protruding laterally from the running bodies.

According to a further preferred embodiment of the invention, the load-bearing body has a connecting element which connects the running bodies one to another, wherein the holding bar runs alongside, in particular at least approximately parallel to this connecting element, is connected by a cantilever arrangement to the connecting element and is supported by the cantilever arrangement such that on its top side it is continuously free over the whole of its length.

Unlike the conveying means from the prior art, the hang-on portion in such a conveying means according to the invention is not the direct connecting element per se, but a holding bar which runs alongside the connecting element and which, at a point beneath its top side, is supported by the support portion arranged on the connecting element. By the term holding bar are meant elongated, bar-like elements or portions. The fact that on their top side they are continuously free over their entire length means that they have a free space above their top side. As is explained in greater detail below, this should not however preclude movable slide stops from being able, where necessary, to be moved through this free space to the hang-on portion.

The free space extending over the entire length of the holding bar facilitates the already described loading of the hang-on portion with the hooks of the article holders. This especially applies where a whole group of conveying means in a conveying means logjam is to be loaded with article holders. The continuous free space above the hang-on portions allows, in a simple manner, a multiplicity of hooks of article holders to be dispensed, in a loading process, to a group of mutually adjoined conveying means. In this context, it is also easily possible, where necessary, to transfer article holders from one conveying means to an adjacent conveying means without having to lift the article holder hooks laterally past interfering contours on the outside. In the known conveying means from the prior art, in which the hang-on portion is formed directly by the connecting element, the running bodies themselves constitute such interfering contours.

According to one embodiment, the connecting element, the support portion and the holding bar are formed out of a common sheet metal bent part. This sheet metal bent part preferably has a hook-shaped cross section with upward pointing hook point belonging to the hang-on portion.

Preferably, however, the load-bearing body is configured as a plastics part, in particular as an injection molded part.

Preferably, the running bodies are fastened to the connecting element in a rotationally movable manner, so that they can make compensating motions about vertical rotation axes when negotiating bends.

According to one embodiment of the invention, the holding bar of the conveying means has close to one of its longitudinal ends an especially upward protruding projection as a slide stop for hooks of article holders. This slide stop prevents the hooks of article holders from sliding down at the particular longitudinal end of the holding bar. Such a slide stop can additionally also be provided close to the other longitudinal end of the holding bar.

According to another variant of the conveying means according to the invention, the holding bar is essentially continuously flat on its top side. This is meant to imply that no elevations in the form of slide stops are provided on the top side of the holding bar. Where appropriate, however, small notches can be provided, which can receive the hooks of article holders. In order to prevent article holders from sliding off the hang-on portions, at least one adjustable slide stop can be provided as an optionally usable limiting element for the hang-on portion. Said slide stop preferably takes the form of an element which is arranged displaceably on the connecting element or on the running body, especially in the vertical direction, between a pass-through setting and a stop setting, and which in its pass-through setting is retracted from the holding bar, so that it does not present an obstacle for hooks sliding on the holding bar, and in its stop setting is brought up to the holding bar to form a barrier for hooks sliding on the holding bar. In this way, the free space on the top side of the holding bar can thus be interrupted if necessary. For the loading or unloading of the conveying means, said free space can be reopened, however, by the retraction of the adjustable sliding stops.

According to a particularly preferred embodiment of the invention, the conveying means can be joined together into jointly handlable conveying means groups, so that the holding bars of mutually adjacent conveying means directly adjoin one another with their longitudinal ends or even laterally overlap one another with complementary overlapping portions. Such an embodiment makes it easier for the conveying means to be loaded in groups in the conveying means logjam and also for the conveying means to be unloaded.

Illustrative embodiments of the invention are explained in greater detail below with reference to the figures.

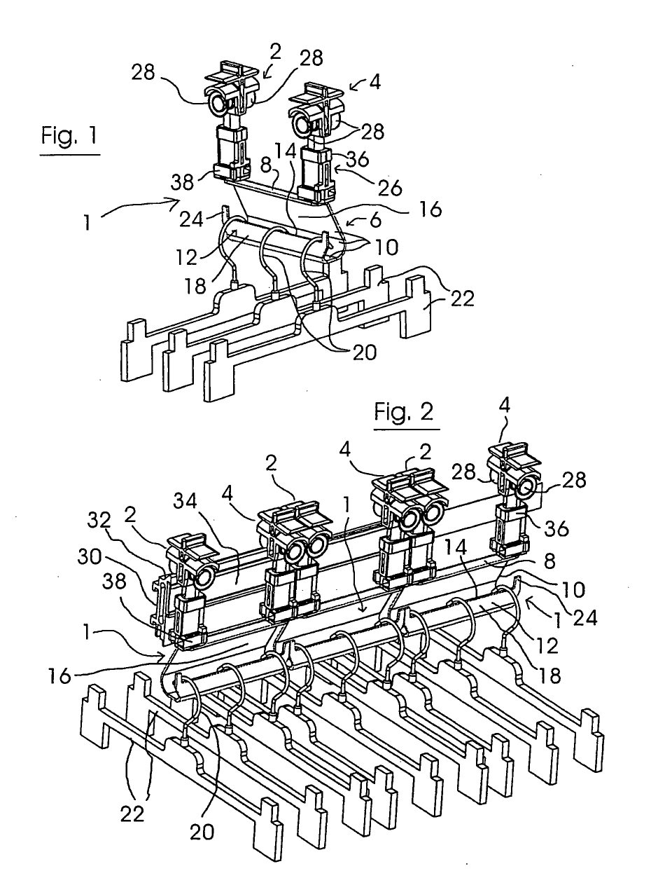

FIG. 1 shows a first illustrative embodiment of a conveying means according to the invention in a perspective representation.

FIG. 2 shows in the arrangement on a guide rail three conveying means of the type shown in FIG. 1 in a conveying means logjam, this likewise in perspective representation.

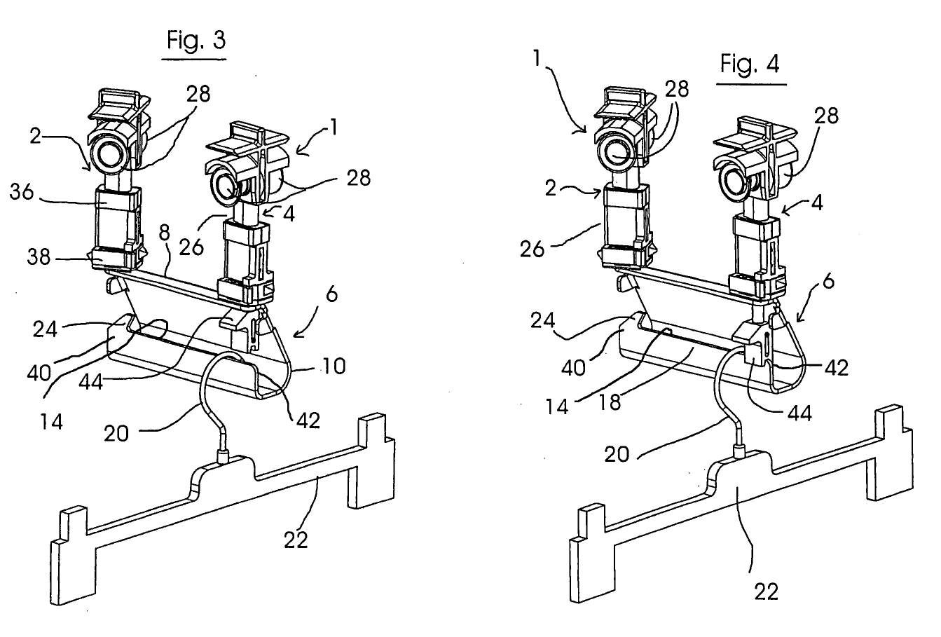

FIGS. 3 and 4 show in a perspective representation a second illustrative embodiment according to the invention, with two different settings of an adjustable slide stop.

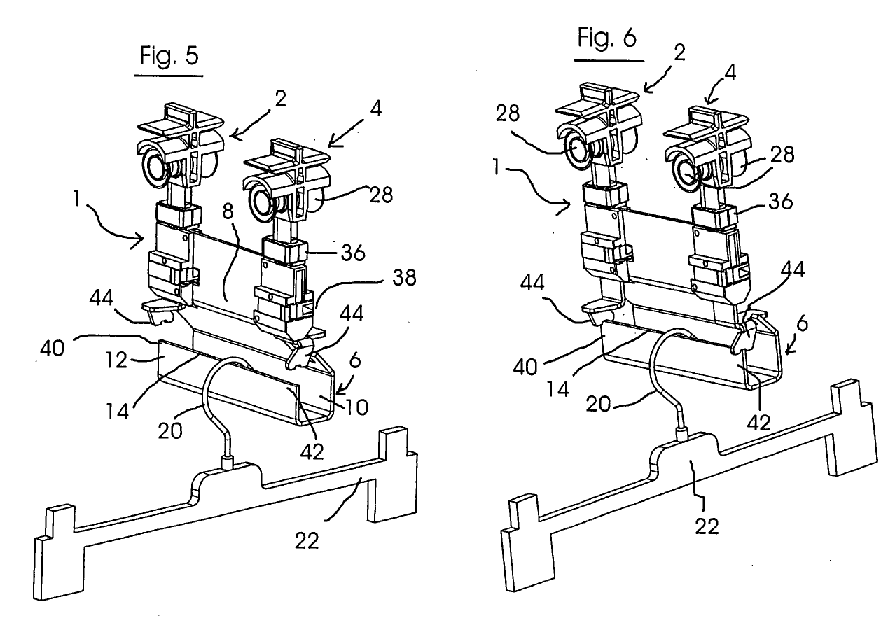

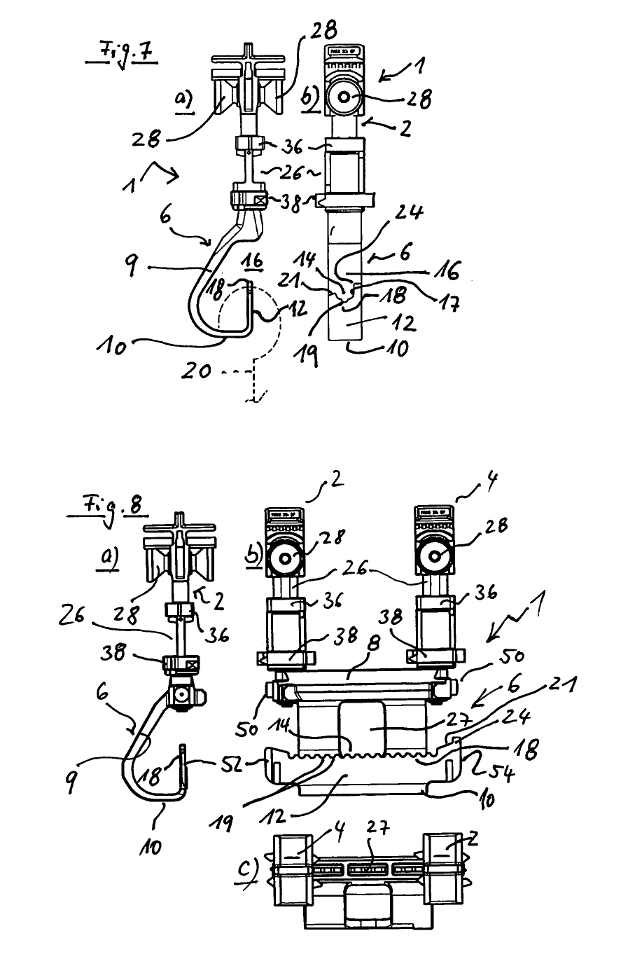

FIGS. 5 and 6 show in a perspective representation a third illustrative embodiment according to the invention, with two different settings of two slide stops.

FIGS. 7a) and b) show as a further illustrative embodiment of a conveying means according to the invention a so-called single hanger carrier having just one running gear, FIG. 7a) showing a front view and FIG. 7b) a side view of the conveying means.

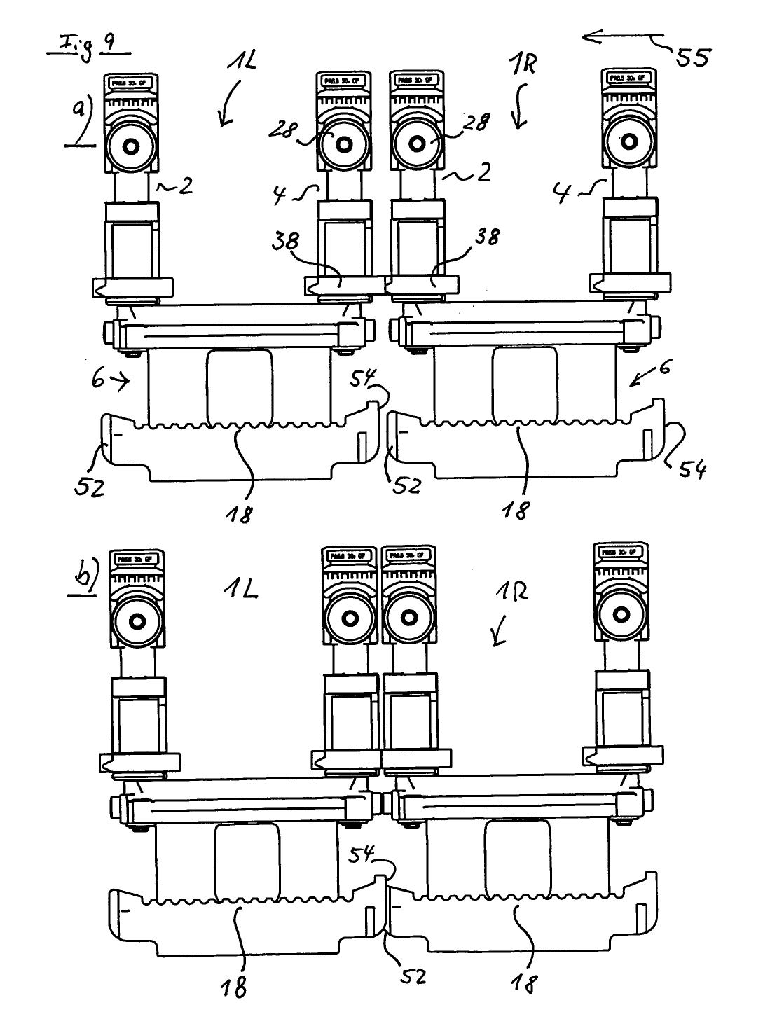

FIGS. 8a)-c) represent in a front view, a side view and a top view a particularly preferred illustrative embodiment of a conveying means according to the invention having two running gears.

FIGS. 9a) and b) show two conveying means of the construction type according to FIG. 8 in two snapshots as they collide to form a conveying means logjam.

The conveying means 1 represented in FIG. 1 has two running bodies 2, 4, which in their lower region are mutually connected by a sheet metal bent part 6 which forms the load-bearing body and which has an upper connecting element 8 in the form of a sheet metal strip extending therebetween from the running body 2 to the running body 4 along or parallel to the shortest connecting line, a cantilever portion 10 which hangs from said sheet metal strip and is multiply folded back to form a hook profile, and a holding bar 12 protruding upward from said cantilever portion. The holding bar 12 lies with its top side 14 in alignment below the vertically aligned running bodies 2, 4 and is supported from below by the cantilever portion 10, so that on its top side 14 it is continuously free over the whole of its length, i.e. has a free space 16. The holding bar 12 forms the hang-on portion 18, on which the hooks 20 of article holders 22 are to be hung, as is shown in the figures based on the example of clothes hangers 22.

In the illustrative embodiment represented in FIGS. 1 and 2, the hang-on portion 18 is limited by two slide stops 24 at the longitudinal ends of the holding bar 12. These slide stops 24 are constituted by projections protruding rigidly upward, which prevent the hooks 20 from sliding off the holding bar during transport. They can also have the function of hook driver elements if the conveying means is loaded automatically.

The running bodies 2, 4 rotatably fastened about the vertical axes to the connecting element sheet metal strip 8 have a structure as known, for example, from the running bodies from EP 0 623 497 A1. Each running body 2, 4 has an elongated frame part 26, which in the conveying operation is normally aligned substantially vertically, and running rollers 28, which are rotatable about a common axis and protrude from the frame part 26 to mutually opposite sides. As can be seen from FIG. 2, the running bodies 2, 4 are to be hung on a guide rail 30 of an overhead conveyor on one side with a respective running roller 28, so that they are transportable along the guide rail 30, the conical running rollers 28 rolling down the complementary running profile 32 of the guide rail 30. Running along the guide rail 30 is a friction belt 34, constituted by an endless belt, which is driven to run around deflection rollers. It serves for the frictional driving of the conveying means 1 and, for this purpose, is in frictional contact with friction coupling means 36 of the conveying means 1. In the event of a logjam of conveying means 1, as is indicated in FIG. 2, the conveying means 1 can mutually detach themselves from the friction belt drive. For this purpose, they have release-tripping means 38, the release-tripping means 38, in the logjam of mutually adjacent running bodies 2, 4 of successive conveying means 1, interacting with each other to pivot the running bodies 2, 4 such that the friction coupling means 36 as far as possible come free from the friction belt 34. As soon as the foremost conveying means 1 in the logjam is freed for onward travel, the conveying means logjam is cleared and the running bodies 2, 4, one after another, regain contact with the friction belt 34, so that the conveying means 1 are again driven onward.

FIG. 2 also reveals that the conveying means 1 can be joined together into jointly handlable conveying means groups, so that the holding bars 12 of mutually adjacent conveying means 1 directly adjoin one another with their longitudinal ends. The free space 16 here extends continuously over all the holding bars 12 of the group of conveying means. This makes it easier to load the conveying means with clothes hangers 22 in groups, as well as to unload the conveying means in groups. Furthermore, the continuous free space 16 allows a simple transfer of clothes hangers 22 from conveying means to conveying means, without the hooks 20 having to be laterally removed from their overlap with the holding bar 12.

FIG. 3 and FIG. 4 show a second illustrative embodiment of the invention. Elements in FIGS. 3 and 4 which, in terms of their structure and their function, substantially correspond to elements in FIGS. 1 and 2 are labeled in FIGS. 3 and 4 with unchanged reference symbols. The second illustrative embodiment differs from the first illustrative embodiment essentially only by virtue of the design of the slide stops. In the second illustrative embodiment, a rigid slide stop 24 is provided at one end 40 of the holding bar 12 as an upward protruding projection, whereas such a slide stop is absent at the other longitudinal end 42 of the holding bar 12. It is thus relatively simple to thread hooks 20 from the longitudinal end 42 onto the hang-on portion 14. In order to prevent hooks 20 from inadvertently sliding off the longitudinal end 42 of the holding bar 12 during transport and from falling off the conveying means 1, an adjustable slide stop 44 is provided, which is held on the connecting element 8 by means of a link guide such that it is vertically displaceable between the pass-through setting shown in FIG. 3 and the stop setting shown in FIG. 4. In the pass-through setting, the adjustable slide stop 44 is retracted sufficiently far from the holding bar 12 that it presents no obstacle to hooks shifting on the holding bar 12. The holding bar 12 is thus, on its top side 14, continuously free over the whole of its length.

In the stop setting according to FIG. 4, the adjustable slide stop 44 is brought sufficiently close to the holding bar 1.2 that it forms a barrier for hooks 20 sliding on the holding bar 12. The setting of the slide stop according to FIG. 4 is usually selected during the transport of the conveying means 1.

The third illustrative embodiment of the invention, shown in FIGS. 5 and 6, has two adjustable slide stops 44, which can be moved independently of each other out of the pass-through setting shown in FIG. 5 into the stop setting shown in FIG. 6, in order, where necessary, to form at both longitudinal ends 40, 42 of the holding bar 12 a barrier for hooks 20 sliding on the holding bar 12. The adjustment of the slide stops 44 can be realized manually or, for example, by means of an external rigid or switchable link bar on the conveying section.

The top side 14 of the holding bar 12 is continuously flat, i.e. it has no elevations in the form of stop projections or the like. In all three illustrative embodiments, the conveying means 1 can be joined together into jointly handlable conveying means groups, so that the holding bars 12 of mutually adjacent conveying means 1 directly adjoin one another with their longitudinal ends.

The conveying means in FIGS. 7a) and 7b) has a single running body 2, which does not substantially differ from the running bodies from the above-described illustrative embodiments of the invention, so that, where the same reference symbols are used as in the preceding illustrative embodiments, reference can be made to the description of the running body pertaining to FIGS. 1-6.

To the lower end of the running body 2 is fastened the load-bearing body 6, which in the front view according to FIG. 7a), and thus viewed in the running direction of the conveying means 1 along a particular guide rail, displays a hook profile, the free hook profile end of which forms the hang-on portion 18, which on its top side 14 is continuously free, i.e. borders on the free space 16.

The portion 10 protruding laterally in a transverse direction from the back of the hook 9 serves here as a cantilever.

As can be seen in FIG. 7b), the hang-on portion 18 has a recess 17—and, in the floor thereof, a further smaller recess 19. The recess 19 serves as a receptacle for a hook 20 of small cross section, i.e. a wire hook of a clothes hanger, for instance. The recess 17 serves for the reception of hang-on means having larger hook cross sections.

The top side 14 of the hang-on portion 18 is also contoured such that an angular face portion 21 and a slide stop 24 are obtained. The contours 21, 24 make it easier for the conveying means 1 to be loaded automatically with an article holder.

Conveying means 1 according to FIG. 7a) and b) can also be joined together in groups to form a conveying means logjam, so that the hang-on portions 18 border one another side by side, which once again makes it easier for the conveying means 1 to be loaded in groups.

In the conveying means according to FIG. 7a) and FIG. 7b), the load-bearing body 6 is preferably made of plastic and can be, for example, a plastics injection molding which also comprises frame parts 24 of the running body.

The conveying means according to the invention which is shown in FIGS. 8a)-8c) is a particularly preferred variant of the model shown in FIG. 1. It has two homogeneous running bodies 2, 4, which correspond to the already discussed running bodies of the preceding illustrative embodiments. The running bodies 2, 4 are connected to each other at their lower ends by the load-bearing body 6. The load-bearing body 6 in FIGS. 8a)-8c) is a plastics part, which has the hook profile, clearly apparent in FIG. 8a), comprising the portions hook back 9, cantilever 10 and hang-on portion 18. The cutouts 27 in the load-bearing body 6 serve to reduce the weight of the conveying means 1.

In FIG. 8b) it can clearly be seen that the hang-on portion 18 has on its top side 14 a corrugation with indentations 19 for receiving a plurality of article holder hooks. At the longitudinal ends of the load-bearing bodies 6, the conveying means 1 in FIGS. 8a)-8c) has shock absorber elements 50. In the given example, these are constituted by rubber buffer elements 50 in the upper region of the load-bearing body 6. These shock absorber elements 50 dampen the shock generated in the collision of two conveying means 1, as occurs, for example, in the piling-up of conveying means 1, in particular on or directly after downhill sections. The impact energy is hereupon transmitted to the load-bearing body 6 by means of the shock absorber elements 50. The ramming shock is thus prevented from acting directly upon the running bodies 2, 4 and from being able to force these out of their guide on the guide rail.

A further, very advantageous feature of the conveying means according to FIG. 8a)-FIG. 8c) is constituted by overlapping zones 52, 54 at the longitudinal ends of the hang-on portion 18. The overlapping zone 52 is an angular face extending continuously from top to bottom, which in the representation according to FIG. 8b) lies on that side of the hang-on portion 18 which is facing the observer. The overlapping portion 54 is a complementary angular face, which in FIG. 8b) lies on that side of the hang-on portion 18 which is facing away from the observer. It should be pointed out that, in place of angular faces 52, 54, mutually complementary trimmings of different type, for instance steps, could also be provided as overlapping portions at the longitudinal ends of the hang-on portion 18.

In FIGS. 9a) and 9b), two snapshots are shown in side views as two conveying means 1 of the construction type shown in FIG. 8 come closer together in a logjam situation. In FIG. 9a), the right-hand conveying means 1R approaches the left-hand conveying means 1L in the direction of conveyance 55, shortly after which the release mechanisms 38 come into effect, so that the right-hand conveying means 1R comes free from its friction belt drive (not shown in FIG. 9) on the guide rail. In the course of this release of the conveying means 1 from the friction belt drive, the mutually facing shock absorber elements 50 of the two conveying means 1R and 1L come together, so that finally the situation according to FIG. 9b) arises, in which the overlapping zone 54 of the conveying means 1L is laterally overlapping the complementary overlapping zone 52 of the conveying means 1R. This prevents a continuous longitudinal gap from forming at right angles to the guide rail between the hang-on portions 18 of the conveying means 1R and 1L lying adjacent to each other in the logjam. When a hook of a clothes hanger is passed over from the conveying means 1L to the conveying means 1R, or vice versa, it is thus easily possible, without running the risk of the clothes hanger hooks falling down between the two conveying means 1L, 1R at the dividing point.

According to one variant of the conveying means, the mutually complementary angular faces 52, 54 can be designed such that, when the conveying means 1R comes closer to the conveying means 1L, the hang-on portion of the conveying means 1R, which, due to the releasing action of the mutually interacting release-tripping means 38, is pivoted laterally outward in the direction of the observer of FIG. 9a), likewise ends up forcing the hang-on portion 18 of the conveying means 1L tendentially laterally outward in order to tend to reduce the drive coupling thereof with the friction belt (not shown), insofar as the conveying means 1L has not anyway been released by another neighboring conveying means.

1. A conveying means for an overhead conveyor, which has at least one running body (2, 4) which can be moved in a hanging state on a guide rail (30) and has a load-bearing body (6) with a hang-on portion (18) for receiving hooks (20) of article holders (22), e.g. clothes hangers,
characterized in that the load-bearing body (6) has a cantilever (10) which, with the conveying means (1) hanging in the intended manner on the guide rail (30), protrudes outward, laterally transversely to the guide rail (30), and has the hang-on portion (18) at its distal end, the hang-on portion (18) being continuously free on its top side, so that it can be accessed from both mutually opposite sides along the guide rail (30) so as to be fitted with a hook (20) of an article holder (22).

2. The conveying means as claimed in claim 1, characterized in that the running body (2, 4) has at least one running roller (28), with which it can be hung on the guide rail (30) for movement thereon, and in that the load-bearing body (6)—viewed in the running direction of the conveying means (1) along the guide rail (30)—displays a hook profile, the free hook profile end of which forms the hang-on portion (18).

3. The conveying means as claimed in claim 2, characterized in that the running body (2, 4) has a running roller pair (28), and in that the running rollers (28) protrude to mutually opposite sides from an elongated frame part (26) which in the conveying operation is normally aligned substantially vertically, the running body (2, 4) having to be hung on the guide rail (30) on one side with a respective running roller (28).

4. The conveying means as claimed in claim 3, characterized in that on the elongated frame part (26) of the running body (2, 4) there are arranged friction coupling means (36) for frictional coupling of the respective running body (2, 4) to a friction belt (34), which is moved along the guide rail (30) in a guided manner and is provided for the frictional transport of the particular conveying means (1) along the conveying section.

5. The conveying means as claimed in claim 4, characterized in that the running body (2, 4) has release-tripping means (38), which, in the event of a logjam of the conveying means on the conveying section, bring about a suspension, or at least a reduction, of the frictional coupling of the friction coupling means (36) to the friction belt (34), the release-tripping means (38), in the logjam of mutually adjacent running bodies (2, 4) of successive conveying means (1), interacting with each other.

6. The conveying means as (claim 1), characterized in that the hang-on portion (18) has at least one receiving recess (17, 19) for hooks (20) of article holders (22).

7. The conveying means as claim 1, characterized in that it has at least two running bodies (2, 4), which can be moved one behind the other in a hanging state on a particular guide rail (30) and are mutually connected, and which jointly support the load-bearing body (6).

8. The conveying means as claimed in claim 7, characterized in that the load-bearing body (6) has an elongated holding bar (12), which runs along, in particular parallel to, a shortest connecting line between the running bodies (2, 4) and is held by means of cantilevers (10) and forms the hang-on portion (18).

9. The conveying means as claimed in claim 8, characterized in that the load-bearing body (6) has a connecting element (8) which connects the running bodies (2, 4) one to another, and in that the holding bar (12) runs alongside, in particular at least approximately parallel to the connecting element (8), is connected by a cantilever arrangement (10) to the connecting element (8) and is supported by the cantilever arrangement (10) such that on its top side (14) it is continuously free over the whole of its length.

10. The conveying means as claimed in claim 9, characterized in that the connecting element (8), the cantilever arrangement (10) and the holding bar (12) are formed out of a common sheet metal bent part (16).

11. The conveying means as claimed in claim 9, characterized in that the load-bearing body (6) is substantially formed by a plastics part.

12. The conveying means as claimed in claim 7, characterized in that the running bodies (2, 4) are fastened to the load-bearing body (8) in a rotationally movable manner.

13. The conveying means as claimed in claim 7, characterized in that the holding bar (12) has close to one of its longitudinal ends an especially upward protruding projection (24) as a slide stop for hooks (20) of article holders (22).

14. The conveying means as claimed in claim 13, characterized in that the holding bar (12) has also close to the other longitudinal end an especially upward protruding projection (24) as a slide stop for hooks of article holders.

15. The conveying means as claimed in claim 7, characterized in that the holding bar is essentially continuously flat on its top side.

16. The conveying means as claimed in claim 1, characterized in that it has at least one adjustable slide stop (44) as an optionally usable limiting element for the hang-on portion (18).

17. The conveying means as claimed in claim 16, characterized in that the adjustable slide stop (44) is an element which is arranged displaceably on the connecting element (8) or on the running body (2, 4), especially in the vertical direction, between a pass-through setting and a stop setting, and which in its pass-through setting is retracted from the holding bar (12), so that it does not present an obstacle for hooks (20) sliding on the holding bar (12), and in its stop setting is brought up to the holding bar (12) to form a barrier for hooks (20) sliding on the holding bar (12).

18. The conveying means as claimed in claim 1, characterized in that the conveying means can be joined together into jointly handlable conveying means groups, so that the hang-on portions (18) of mutually adjacent conveying means directly adjoin one another with their longitudinal ends.

19. The conveying means as claimed in claim 1, characterized in that at least one longitudinal end, in particular at both longitudinal ends, it has a respective shock absorber element (50) on the load-bearing body (6).

20. The conveying means as claimed in claim 1, characterized in that at the longitudinal ends of the hang-on portion (18) it has complementarily shaped overlapping portions (52, 54) on opposite lateral sides of the hang-on portion (18), which allow a lateral overlap with the particular overlapping portions (54, 52) of successive conveying means (1L, 1R) in a conveying means logjam.
